(19) United States
(12) Patent Application Publication
(10) Pub. No.: US 2020/0398340 A1
(43) Pub. Date: Dec. 24, 2020

(54) IRRADIATION DEVICE, METAL SHAPING DEVICE, METAL SHAPING SYSTEM, IRRADIATION METHOD, AND METHOD FOR MANUFACTURING METAL SHAPED OBJECT

(71) Applicant: FUJIKURA LTD., Tokyo (JP)

(72) Inventors: Hiroyuki Kusaka, Sakura-shi (JP); Masahiro Kashiwagi, Sakura-shi (JP)

(73) Assignee: FUJIKURA LTD., Tokyo (JP)

(21) Appl. No.: 16/979,266

(22) PCT Filed: Mar. 25, 2019
(86) PCT No.: PCT/JP2019/012380

§ 371 Date: Sep. 9, 2020

(30) Foreign Application Priority Data
Mar. 30, 2018 (JP) 2018-069698

(51) Int. Cl. B22F 3/10; B22F 3/105; B23K 26/06

(52) U.S. Cl. CPC B22F 3/1017; B22F 3/1055; B33Y 10/00; B23K 26/0665; B23K 26/0648

(57) ABSTRACT

The present invention keeps a residual stress small which may occur in a metal shaped object (MO) while keeping a time short which is to be taken for carrying out main heating and preheating. An irradiation device (13) carries out a first heating step of heating a powder bed (PB) with laser light (LL) so that a temperature (T) of the powder bed (PB) is higher than 0.8 times as high as a melting point (Tm) of the metal powder and a second heating step of heating the powder bed (PB) with cladding light (CL) before or after the first heating step so that a temperature (T) of the powder bed (PB) is 0.5 times to 0.8 times as high as the melting point (Tm) of the metal powder.

### TECHNICAL FIELD

The present invention relates to an irradiation device and an irradiation method which are used in metal shaping. The present invention also relates to a metal shaping device including such an irradiation device and a metal shaping system including such a metal shaping device. The present invention also relates to a method for manufacturing a metal shaped object including such an irradiation method.

### BACKGROUND ART

As a method for manufacturing a three-dimensional metal shaped object, an additive manufacturing method is known in which a powder bed is used as a base material. The additive manufacturing method includes (1) an electron beam melting method in which a powder bed is melted and solidified, or sintered with use of an electron beam, and (2) a laser beam melting method in which a powder bed is melted and solidified, or sintered with use of a laser beam (see Non-Patent Literature 1).

In the additive manufacturing method using electron beam melting, it is necessary to carry out preheating (sometimes referred to as “preliminary heating”) for temporarily sintering the powder bed before carrying out main heating with irradiation with an electron beam. This is because, in a case where the powder bed that has not been temporarily sintered is irradiated with the electron beam, a smoke phenomenon tends to occur in which metal powder constituting the powder bed flies up like smoke, and it is thus difficult to form a normal molten pool. It is known that, in the preheating, a temperature of the powder bed only needs to be set to a temperature which is 0.5 times to 0.8 times as high as a melting point of the metal powder.

### CITATION LIST

### Non-Patent Literature

[Non-patent Literature 1]
“Microstructure of Alloys Fabricated by Additive Manufacturing Using Electron Beam Melting” by Akihiko Chiba, Journal of the Society of Instrument and Control Engineers, Vol. 54, No. 6, June 2015, p 399-400

### SUMMARY OF INVENTION

### Technical Problem

As described above, in the additive manufacturing method using electron beam melting, preheating is typically carried out for temporarily sintering the powder bed before carrying out main heating with irradiation with an electron beam. From this, the additive manufacturing method using electron beam melting has the following disadvantage and advantage. The disadvantage is that a time taken for carrying out additive manufacturing of the metal shaped object is longer because the preheating is carried out before the main heating. In contrast, the advantage is that a residual stress that may occur in the obtained metal shaped object is small. This is considered as a secondary effect obtained by carrying out the preheating with respect to the powder bed.

In contrast, in the additive manufacturing method using laser beam melting, charge-up of the metal powder cannot occur unlike in the additive manufacturing method using electron beam melting, and therefore the above described smoke phenomenon cannot occur. From this, in the additive manufacturing method using laser beam melting, the preheating for temporarily sintering the powder bed is usually not carried out before the main heating which is carried out by irradiation with the laser beam. For this, the additive manufacturing method using laser beam melting has the following advantage and disadvantage. The advantage is that a time taken for carrying out additive manufacturing of the metal shaped object can be kept short because preheating is not carried out before the main heating. In contrast, the disadvantage is that a residual stress that may occur in the obtained metal shaped object is large.

Therefore, in the additive manufacturing method using laser beam melting, it is demanded to reduce the disadvantage while maintaining the advantage. In other words, a residual stress that may occur in the obtained metal shaped object needs to be kept small while keeping a time short which is to be taken for carrying out additive manufacturing of the metal shaped object.

The present invention is accomplished in view of the above problems, and an object of the present invention is to provide an irradiation device employing an additive manufacturing method using laser beam melting, a metal shaping device, a metal shaping system, an irradiation method, and a method for manufacturing a metal shaped object, which are capable of keeping a residual stress small which may occur in the obtained metal shaped object while keeping a time short which is to be taken for carrying out additive manufacturing of the metal shaped object.

### Solution to Problem

In order to attain the object, the irradiation device in accordance with an aspect of the present invention is an irradiation device for use in metal shaping, the irradiation device including: an irradiating section which irradiates at least a part of a powder bed containing metal powder with laser light guided through a core of an optical fiber and with cladding light guided through a cladding of the optical fiber, the irradiating section carrying out a first heating step of heating the powder bed with the laser light so that a temperature of the powder bed is higher than 0.8 times as high as a melting point of the metal powder, and the irradiating section carrying out a second heating step of heating the powder bed with the cladding light before or after the first heating step so that a temperature of the powder bed is 0.5 times to 0.8 times as high as the melting point of the metal powder.

In order to attain the object, an irradiation method in accordance with an aspect of the present invention includes: an irradiating step of irradiating at least a part of a powder bed containing metal powder with laser light guided through a core of an optical fiber and with cladding light guided through a cladding of the optical fiber, the irradiating step including a first heating step of heating the powder bed with the laser light so that a temperature of the powder bed is higher than 0.8 times as high as a melting point of the metal powder, and the irradiating step including a second heating step of heating the powder bed with the cladding light before or after the first heating step so that a temperature of the powder bed is 0.5 times to 0.8 times as high as the melting point of the metal powder.

In order to attain the object, a method for manufacturing a metal shaped object in accordance with an aspect of the present invention includes: an irradiating step of irradiating at least a part of a powder bed containing metal powder with laser light guided through a core of an optical fiber and with cladding light guided through a cladding of the optical fiber, the irradiating step including a first heating step of heating the powder bed with the laser light so that a temperature of the powder bed is higher than 0.8 times as high as a melting point of the metal powder, and the irradiating step including a second heating step of heating the powder bed with the cladding light before or after the first heating step so that a temperature of the powder bed is 0.5 times to 0.8 times as high as the melting point of the metal powder.

### Advantageous Effects of Invention

According to an aspect of the present invention, it is possible to provide an irradiation device, a metal shaping device, a metal shaping system, an irradiation method, and a method of manufacturing a metal shaped object, which are capable of keeping a residual stress small which may occur in the obtained metal shaped object while keeping a time short which is to be taken for carrying out additive manufacturing of the metal shaped object.

### BRIEF DESCRIPTION OF DRAWINGS

FIG. 1 is a block diagram illustrating a configuration of a metal shaping system in accordance with an embodiment of the present invention.

FIG. 2 is a cross-sectional view illustrating a configuration of an optical fiber included in the metal shaping system illustrated in FIG. 1.

(a) of FIG. 3 is a block diagram illustrating a configuration of an irradiation device included in the metal shaping system illustrated in FIG. 1. (b) of FIG. 3 is a plan view illustrating a powder bed used in the metal shaping system illustrated in FIG. 1.

FIG. 4 is a flowchart showing a flow of a method for manufacturing a metal shaped object in accordance with an embodiment of the present invention.

FIG. 5 is a block diagram illustrating a modification example of the metal shaping system illustrated in FIG. 1.

### DESCRIPTION OF EMBODIMENTS

(Configuration of Metal Shaping System)

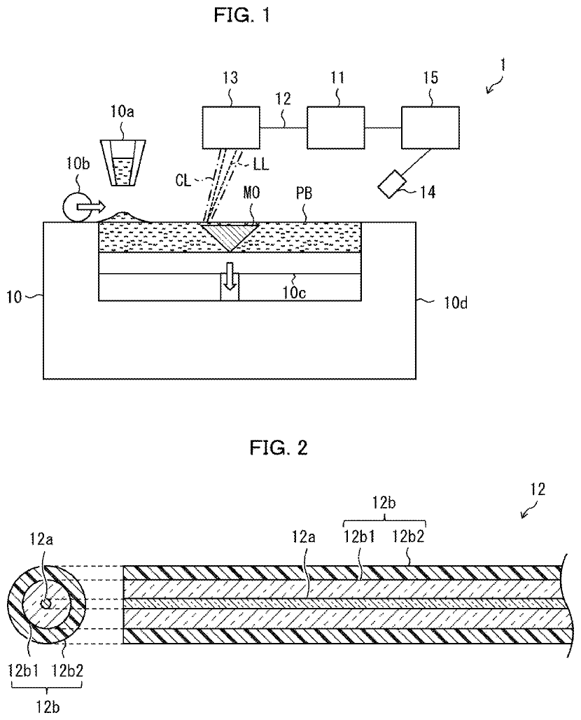

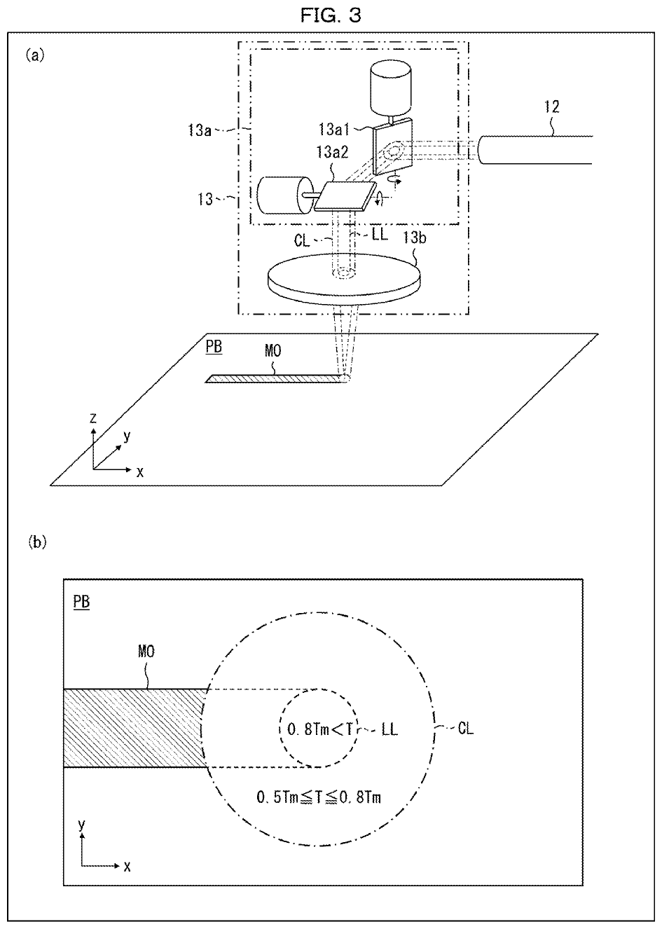

The following description will discuss a metal shaping system 1 in accordance with an embodiment of the present invention with reference to FIGS. 1 through 3. FIG. 1 is a block diagram illustrating a configuration of the metal shaping system 1. FIG. 2 is a cross-sectional view illustrating a configuration example of an optical fiber 12 which will be described later. (a) of FIG. 3 is a block diagram illustrating a configuration example of an irradiation device 13 (described later), and (b) of FIG. 3 is a plan view illustrating a powder bed PB (described later).

The metal shaping system 1 is a system for additive manufacturing of a three-dimensional metal shaped object MO. As illustrated in FIG. 1, the metal shaping system 1 includes a shaping table 10, a laser device 11, an optical fiber 12, an irradiation device 13, a measuring section 14, and a control section 15. In this specification, a main part of the metal shaping system 1 is referred to as “metal shaping device”. The metal shaping device includes at least the optical fiber 12 and the irradiation device 13 and can include the measuring section 14 and the control section 15.

In this section, the shaping table 10, the laser device 11, the optical fiber 12, and the irradiation device 13 will be described, and then effects brought about by those constituent members will be described. The measuring section 14 and the control section 15 will be described in the next section.

The shaping table 10 is a constituent member for holding the powder bed PB. The shaping table 10 can be constituted by, for example, a recoater 10a, a roller 10b, a stage 10c and a table main body 10d which is provided with those components (see FIG. 1). The recoater 10a is a member for supplying metal powder. The roller 10b is a member for spreading the metal powder supplied by the recoater 10a evenly over the stage 10c. The stage 10c is a member on which the metal powder evenly spread by the roller 10b is to be placed, and the stage 10c is configured to be elevated and lowered. The powder bed PB contains the metal powder which has been evenly spread over the stage 10c. The metal shaped object MO is shaped for each layer having a predetermined thickness by repeating the following steps (1) through (3): i.e., (1) a step of forming a powder bed PB on the stage 10c as described above; (2) a step of forming one layer of the metal shaped object MO by irradiating the powder bed PB with laser light LL and cladding light CL as described later; and (3) a step of lowering the stage 10c by one layer.

The shaping table 10 only needs to serve a function of holding the powder bed PB, and the configuration of the shaping table 10 is not limited to the configuration described above. For example, a configuration can be employed in which a powder bath containing the metal powder is provided instead of the recoater 10a and the metal powder is supplied by elevating a bottom plate of the powder bath.

The laser device 11 is a constituent member for outputting laser light LL. In the present embodiment, a fiber laser is used as the laser device 11. From this, light outputted from the laser device 11 can include residual excitation light in addition to the laser light LL. Here, the residual excitation light refers to excitation light which (i) remains in the excitation light outputted from an excitation light source of the fiber laser and (ii) is not used to excite a rare-earth element added to a core of an amplifying optical fiber of the fiber laser.

The fiber laser used as the laser device 11 can be a resonator type fiber laser or a master oscillator-power amplifier (MOPA) type fiber laser. In other words, the laser device 11 can be a continuous-wave type fiber laser or a pulsed oscillation type fiber laser. Alternatively, the laser device 11 can be a laser device other than the fiber laser. Any laser device such as a solid laser, a liquid laser, or a gas laser can be used as the laser device 11.

The optical fiber 12 is a constituent member which guides light outputted from the laser device 11. In the present embodiment, a double cladding fiber is used as the optical fiber 12. That is, as illustrated in FIG. 2, the optical fiber 12 includes a core 12a and a cladding 12b that covers a lateral surface of the core 12a. Here, the cladding 12b is constituted by an inner cladding 12b1 that covers the lateral surface of the core 12a and an outer cladding 12b2 that covers a lateral surface of the inner cladding 12b1.

In the optical fiber 12, the lateral surface of the core 12a is entirely covered with the inner cladding 12b1, which has a refractive index lower than that of the core 12a, over an entire length of the optical fiber 12. In the optical fiber 12, the lateral surface of the inner cladding 12b1 is entirely covered with an outer cladding 12b2, which has a refractive index lower than that of the inner cladding 12b1, over the entire length of the optical fiber 12. This is because no structure such as a cladding mode stripper is provided which removes the outer cladding 12b2 to expose the inner cladding 12b1. Therefore, in the optical fiber 12, both the core 12a and the inner cladding 12b1 function as light guide paths. The laser light LL outputted from the laser device 11 is mainly guided through the core 12a of the optical fiber 12. Meanwhile, the residual excitation light outputted from the laser device 11 is mainly guided through the inner cladding 12b1 of the optical fiber 12.

Note that the light guided through the inner cladding 12b1 of the optical fiber 12 can include leaked higher order mode light in addition to the residual excitation light described above. Here, the leaked higher order mode light refers to higher order mode light leaked into the inner cladding 12b1 from higher order mode light in the core 12a. Hereinafter, light guided through the inner cladding 12b1 of the optical fiber 12 is referred to as “cladding light CL” regardless of its origin. The cladding light CL can include other light in addition to the residual excitation light and the leaked higher order mode light described above.

Note that the optical fiber 12 is not limited to the double cladding fiber. Any optical fiber (such as triple cladding fiber) having two or more layers of cladding can be used as the optical fiber 12. In such a case, an outermost cladding can serve a function equivalent to the outer cladding of the double cladding fiber, and any of the other claddings can serve a function equivalent to the inner cladding of the double cladding fiber.

The irradiation device 13 is a constituent member for irradiating the powder bed PB with the laser light LL guided through the core 12a of the optical fiber 12 and with the cladding light CL guided through the inner cladding 12b1 of the optical fiber 12. In the present embodiment, a galvano type irradiation device is used as the irradiation device 13. That is, as illustrated in (a) of FIG. 3, the irradiation device 13 includes (i) a galvano scanner 13a (an example of an “irradiating section” in claims) including a first galvano mirror 13a1 and a second galvano mirror 13a2, (ii) a condensing lens 13b, and (iii) a housing (not illustrated) for accommodating those components. The laser light LL and the cladding light CL outputted from the optical fiber 12 are (1) reflected by the first galvano mirror 13a1, (2) reflected by the second galvano mirror 13a2, (3) condensed by the condensing lens 13b, and then reach the powder bed PB.

Here, the first galvano mirror 13a1 is a constituent member for moving beam spots of the laser light LL and the cladding light CL formed on a surface of the powder bed PB in a first direction (e.g., an x-axis direction indicated in FIG. 3). The second galvano mirror 13a2 is a constituent member for moving the beam spots of the laser light LL and the cladding light CL formed on the surface of the powder bed PB in a second direction (e.g., a y-axis direction indicated in FIG. 3) that intersects (e.g., is orthogonal to) the first direction. The condensing lens 13b is a constituent member for reducing diameters of the beam spots of the laser light LL and the cladding light CL on the surface of the powder bed PB.

Note that the beam spot diameter of the laser light LL on the surface of the powder bed PB can either be identical with or different from a beam waist diameter of the laser light LL condensed by the condensing lens 13b. Alternatively, the beam spot diameter of the laser light LL on the surface of the powder bed PB can be adjusted so that an energy density of the laser light LL with which the powder bed PB is irradiated becomes an intended energy density. In this case, the beam spot diameter of the laser light LL on the surface of the powder bed PB is greater than the beam waist diameter of the laser light LL condensed by the condensing lens 13b.

As illustrated in (b) of FIG. 3, the beam spot of the cladding light CL on the surface of the powder bed PB encompasses the beam spot of the laser light LL on the surface of the powder bed PB. That is, the size of the beam spot of the cladding light CL on the surface of the powder bed PB is greater than the size of the beam spot of the laser light LL on the surface of the powder bed PB. Note that the beam spots of the laser light LL and the cladding light CL have sizes corresponding to the diameter of the core 12a and the diameter of the inner cladding 12b1 of the optical fiber 12, respectively. This is because the laser light LL is emitted from the core 12a and the cladding light CL is emitted from the inner cladding 12b1 which has the diameter greater than that of the core 12a. In addition, in a case where there is a chromatic aberration in the condensing lens 13b, the beam spots of the laser light LL and the cladding light CL have sizes corresponding to a wavelength of the laser light LL and a wavelength of the cladding light CL, respectively. This is because a focal length of the laser light LL and a focal length of the cladding light CL are lengths respectively corresponding to the wavelength of the laser light LL and the wavelength of the cladding light CL. Accordingly, the sizes of the beam spots of the laser light LL and the cladding light CL can be adjusted, for example, by (i) changing the diameters of the core 12a and the inner cladding 12b1 of the optical fiber 12 or (ii) changing the diameters of the laser light LL and the cladding light CL.

The irradiation device 13 heats the powder bed PB with the laser light LL so that a temperature T of the powder bed PB is higher than 0.8 times as high as a melting point Tm of the metal powder (hereinafter referred to as “main heating”; an example of “first heating step” in claims). Therefore, as illustrated in (b) of FIG. 3, the temperature T of the powder bed PB is 0.8 Tm<T in the beam spot of the laser light LL. Note that, in the beam spot of the laser light LL, irradiation with the cladding light CL can concurrently occur in addition to irradiation with the laser light LL. Thus, the main heating described in this paragraph includes: (1) an aspect in which the temperature T of the powder bed PB is increased, with only the laser light LL, to be higher than 0.8 times as high as the melting point Tm of the metal powder in the beam spot of the laser light LL; and (2) an aspect in which the temperature T of the powder bed PB is increased, with the laser light LL and the cladding light CL, to be higher than 0.8 times as high as the melting point Tm of the metal powder in the beam spot of the laser light LL.

In particular, in a case where each layer of the metal shaped object MO is formed by melting and solidifying the metal powder, the irradiation device 13 carries out main heating with respect to the powder bed PB with the laser light LL so that the temperature T of the powder bed PB is equal to or higher than the melting point Tm of the metal powder. In this case, the temperature T of the powder bed PB is Tm≤T in the beam spot of the laser light LL. Thus, in a case where the powder bed PB is scanned with the laser light LL, the powder bed PB is melted and solidified on a track of the beam spot of the laser light LL. This forms each layer of the metal shaped object MO. Note that, in the beam spot of the laser light LL, irradiation with the cladding light CL can concurrently occur in addition to irradiation with the laser light LL. Thus, the main heating described in this paragraph includes: (1) an aspect in which the temperature T of the powder bed PB is increased, with only the laser light LL, to be equal to or higher than the melting point Tm of the metal powder in the beam spot of the laser light LL; and (2) an aspect in which the temperature T of the powder bed PB is increased, with the laser light LL and the cladding light CL, to be equal to or higher than the melting point Tm of the metal powder in the beam spot of the laser light LL.

Meanwhile, in a case where each layer of the metal shaped object MO is formed by sintering the metal powder, the irradiation device 13 carries out main heating with respect to the powder bed PB with the laser light LL so that the temperature T of the powder bed PB is (i) higher than 0.8 times as high as the melting point Tm of the metal powder and (ii) lower than the melting point Tm of the metal powder. In this case, the temperature T of the powder bed PB is 0.8 Tm<T<Tm in the beam spot of the laser light LL. Thus, in a case where the powder bed PB is scanned with the laser light LL, the powder bed PB is sintered on a track of the beam spot of the laser light LL. This forms each layer of the metal shaped object MO. Note that, in the beam spot of the laser light LL, irradiation with the cladding light CL can concurrently occur in addition to irradiation with the laser light LL. Thus, the main heating described in this paragraph includes: (1) an aspect in which the temperature T of the powder bed PB is increased, with only the laser light LL, to be (i) higher than 0.8 times as high as the melting point Tm of the metal powder and (ii) lower than the melting point Tm of the metal powder in the beam spot of the laser light LL; and (2) an aspect in which the temperature T of the powder bed PB is increased, with the laser light LL and the cladding light CL, to be (i) higher than 0.8 times as high as the melting point Tm of the metal powder and (ii) lower than the melting point Tm of the metal powder in the beam spot of the laser light LL.

The irradiation device 13 heats the powder bed PB with the cladding light CL so that the temperature T of the powder bed PB is 0.5 times to 0.8 times as high as the melting point Tm of the metal powder (hereinafter referred to as “preheating”; an example of “second heating step” in claims). Thus, as illustrated in (b) of FIG. 3, the temperature T of the powder bed PB is 0.5 Tm≤T≤0.8 Tm in the beam spot of the cladding light CL.

In a case where the beam spots of the laser light LL and the cladding light CL are formed as illustrated in (b) of FIG. 3 and the powder bed PB is scanned with the laser light LL, points on a track of the beam spot of the laser light LL are subjected to (1) preheating with the cladding light CL, (2) main heating with the laser light LL, and (3) preheating with the cladding light CL, in this order. In other words, for each point on the track of the beam spot of the laser light LL, the preheating with the cladding light CL is carried out before and after the main heating with the laser light LL. This allows a residual stress that may occur in the metal shaped object MO to be kept as small as in additive manufacturing using an electron beam. In addition, the main heating with the laser light LL and the preheating with the cladding light CL are carried out in parallel. In particular, in the present embodiment, a single galvano scanner 13a is used in irradiation with the laser light LL and irradiation with the cladding light CL. Therefore, the main heating with the laser light LL and the preheating with the cladding light CL are carried out without a large interval (i.e., time interval and/or spatial interval). It is therefore unnecessary to spend extra time to carry out the preheating. In addition, there is no need to provide extra equipment for the preheating.

In the present embodiment, beam spots of the laser light LL and the cladding light CL are formed so that the preheating with the cladding light CL is carried out before and after the main heating with the laser light LL. Note, however, that the present embodiment is not limited to this. That is, the beam spots of the laser light LL and the cladding light CL can be formed such that preheating with the cladding light CL is carried out only before main heating with the laser light LL, or such that preheating with the cladding light CL is carried out only after main heating with the laser light LL. In both cases, it is possible to bring about an effect of reducing the residual stress that may occur in the metal shaped object MO.

Note that, in a case where the preheating is carried out before the main heating, the following advantages can be obtained. The first advantage is that the lamination density in the metal shaped object MO is hardly dropped. That is, in a case where the preheating is not carried out before the main heating, the powder bed PB is rapidly heated during the main heating. From this, a metallic liquid produced by melting of the metal powder tends to have a high momentum, and consequently flatness of a surfaces of a metallic solid produced by solidification of the metallic liquid tends to be deteriorated. This makes it easier to lower the lamination density of the metal shaped object MO. In contrast, in a case where the preheating is carried out before the main heating, temperature rise of the powder bed PB during the main heating can be slowed down. This makes it difficult for the metallic liquid produced by melting of the metal powder to have a high momentum, and consequently the flatness of the surfaces of the metallic solid produced by solidification of the metallic liquid is hardly deteriorated. This makes it difficult to lower the lamination density of the metal shaped object MO.

The second advantage is that it is possible to reduce power of laser light emitted during the main heating. The power of the laser light emitted during the main heating can be kept low because the temperature T of the powder bed PB in carrying out the main heating has already been raised to some extent by the preheating.

The third advantage is that unevenness in temperature T of the powder bed PB depending on locations during the main heating can be kept small. For example, the following description assumes a case where the temperature T of the powder bed PB is increased from 20° C. to 1000° C. by carrying out main heating without preheating. In this case, the temperature rise during the main heating is approximately 1000° C. Thus, if the unevenness is ±10%, the temperature T of the powder bed PB during the main heating will vary in a range from approximately 900° C. to approximately 1100° C. As such, if the unevenness of the temperature T of the powder bed PB during the main heating is large, a problem tends to occur in which excessive heating is carried out at a certain location, and insufficient heating is carried out at another location. In contrast, the following description assumes a case where the temperature T of the powder bed PB is increased to 600° C. by carrying out preheating and then the temperature T of the powder bed PB is increased from 600° C. to 1000° C. by carrying out main heating. In this case, the temperature rise during the main heating is approximately 400° C. Thus, if the unevenness is ±10%, the temperature T of the powder bed PB during the main heating will vary in a range from approximately 960° C. to approximately 1040° C. As such, in a case where the unevenness of the temperature T of the powder bed PB during the main heating is small, the problem hardly occurs in which excessive heating is carried out at a certain location, and insufficient heating is carried out at another location.

Meanwhile, in a case where the preheating is carried out after the main heating, an advantage of further reducing the residual stress that may occur in the metal shaped object MO can be obtained. This is because (i) the preheating reduces a difference in temperature between a region subjected to main heating and its surrounding regions and, in addition, (ii) temperature drop of at least one or some layers of the solidified or sintered metal shaped object MO after the main heating is completed can be moderated.

As described above, according to the irradiation device 13, it is possible to bring about an effect of keeping the residual stress small which may occur in the metal shaped object MO while keeping a time short which is to be taken for carrying out additive manufacturing of the metal shaped object MO. The metal shaping device including the irradiation device 13 and the metal shaping system 1 including the metal shaping device also bring about similar effects.

In particular, in the present embodiment, the cladding 12b of the optical fiber 12 includes (i) the inner cladding 12b1 which guides the cladding light CL and (ii) the outer cladding 12b2 which entirely covers the lateral surface of the inner cladding 12b1 over the entire length of the optical fiber 12. That is, in the irradiation device 13, the lateral surface of the inner cladding 12b1 is covered completely with the outer cladding 12b2 which has the refractive index lower than that of the inner cladding 12b1. This improves effectiveness of confining the cladding light CL in the inner cladding 12b1. Therefore, the preheating of the powder bed PB can be carried out by efficiently utilizing the cladding light CL. The metal shaping device including the irradiation device 13 and the metal shaping system 1 including the metal shaping device also bring about similar effects.

According to the present embodiment, the optical fiber 12 is not provided with a cladding mode stripper for removing the cladding light CL. From this, the cladding light CL is hardly removed, and therefore the preheating of the powder bed PB can be carried out by efficiently utilizing the cladding light CL. The metal shaping device including the irradiation device 13 and the metal shaping system 1 including the metal shaping device also bring about similar effects.

According to the present embodiment, the irradiation device 13 includes the condensing lens 13b for forming, on the surface of the powder bed, a beam spot of the laser light LL and a beam spot of the cladding light CL having a beam spot size larger than that of the laser light LL. Therefore, according to the irradiation device 13, it is possible to increase power densities of the laser light LL and the cladding light CL with which the powder bed PB is irradiated. From this, even in a case where powers of the laser light LL and the cladding light CL are relatively low, the temperature T of the powder bed PB in the beam spots of the laser light LL and the cladding light CL can be raised to satisfy the aforementioned condition. This makes it possible to bring about an effect of reducing electric power which is to be consumed to raise the temperature T of the powder bed PB in the beam spots of the laser light LL and the cladding light CL so as to meet the aforementioned condition. The metal shaping device including the irradiation device 13 and the metal shaping system 1 including the metal shaping device also bring about similar effects.

According to the present embodiment, the laser device 11 is the fiber laser, and therefore residual excitation light may be included in the cladding light CL. In this case, according to the irradiation device 13, the preheating can be carried out by utilizing the residual excitation light which has been removed as unnecessary light in conventional techniques. That is, it is possible to bring about an effect of carrying out the preheating without separately providing a light source for the preheating. In addition, in this case, it is not necessary to remove the outer cladding 12b2 for exposing the inner cladding 12b1 or to provide a cladding mode stripper in the optical fiber 12 in order to eliminate the residual excitation light. Therefore, the configuration can be simplified. The metal shaping device including the irradiation device 13 and the metal shaping system 1 including the metal shaping device also bring about similar effects.

According to the present embodiment, leaked higher order mode light may be included in the cladding light CL. In this case, according to the irradiation device 13, the preheating can be carried out by utilizing the leaked higher order mode light which has been removed as unnecessary light in conventional techniques. That is, it is possible to bring about an effect of carrying out the preheating without separately providing a light source for the preheating. In addition, in this case, it is not necessary to remove the outer cladding 12b2 for exposing the inner cladding 12b1 or to provide a cladding mode stripper in the optical fiber 12 in order to eliminate the leaked higher order mode light. Therefore, the configuration can be simplified. The metal shaping device including the irradiation device 13 and the metal shaping system 1 including the metal shaping device also bring about similar effects.

The power of the leaked higher order mode light is increased by bending or winding the optical fiber 12 or by forming or inserting a long-period fiber Bragg grating in the optical fiber 12. Therefore, in order to obtain intended power of the cladding light CL, it is possible to employ a configuration in which the optical fiber 12 is bent or wound, and/or a configuration in which a long-period fiber Bragg grating is formed or inserted in the optical fiber 12.

(Measuring Section and Control Section)

As described above, the metal shaping device can include the measuring section 14 and the control section 15. In this section, the measuring section 14 and the control section 15 will be described. In FIG. 1, the line connecting the measuring section 14 with the control section 15 represents a signal line for transmitting a signal indicative of a measured result obtained by the measuring section 14 to the control section 15, and the measuring section 14 and the control section 15 are electrically or optically connected to each other. In FIG. 1, the line connecting the control section 15 with the laser device 11 represents a signal line for transmitting a control signal generated by the control section 15 to the laser device 11, and the control section 15 and the laser device 11 are electrically or optically connected to each other. Although not illustrated, at least one of the constituent members of the irradiation device 13 can be optically or electrically connected with the control section 15 in a manner similar to that described above. In this case, for example, it is possible to employ a configuration in which a control signal generated by the control section 15 is transmitted to at least one constituent member of the irradiation device 13 so that the control section 15 controls the at least one constituent member.

The measuring section 14 is a constituent member for measuring a temperature T (e.g., a surface temperature) of the powder bed PB. As the measuring section 14, for example, a thermographic camera can be used.

The control section 15 is a constituent member for controlling power of the cladding light CL so that the temperature T of the powder bed PB is 0.5 Tm≤T≤0.8 Tm in the beam spot of the cladding light CL. As described above, Tm refers to the melting point of the metal powder contained in the powder bed PB. In the present embodiment, the control section 15 controls the power of the cladding light CL based on a temperature measured by the measuring section 14. As the control section 15, for example, a microcomputer can be used. A method of controlling the power of the cladding light CL can be, for example, a method in which residual excitation light is controlled by controlling the excitation light source of the fiber laser (laser device 11). The control section 15 can further control, based on the temperature measured by the measuring unit 14, the power of the laser light so that the temperature T of the powder bed PB is 0.8 Tm<T in the beam spot of the laser light LL.

According to the metal shaping device including the measuring section 14 and the control section 15, and the metal shaping system 1 including such a metal shaping device, it is possible to bring about an effect of appropriately carrying out the preheating with the cladding light even in a case where various conditions change. The various conditions herein include, for example, an air temperature, a type of the metal powder, a grain diameter of the metal powder, and the like.

(Method for Manufacturing Metal Shaped Object)

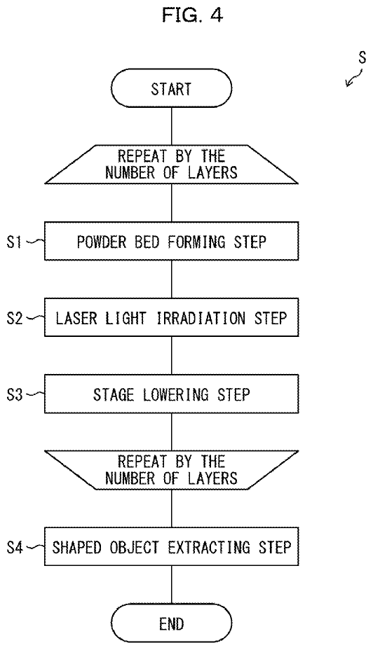

The following description will discuss a manufacturing method S for manufacturing a metal shaped object MO using the metal shaping system 1 with reference to FIG. 4. FIG. 4 is a flowchart showing a flow of the manufacturing method S.

As illustrated in FIG. 4, the manufacturing method S includes a powder bed forming step S1, a laser light irradiation step S2 (an example of “irradiation method” in claims), a stage lowering step S3, and a shaped object extracting step S4. The metal shaped object MO is formed layer by layer as described above. The powder bed forming step S1, the laser light irradiation step S2, and the stage lowering step S3 are repeatedly carried out the number of times which corresponds to the number of layers.

The powder bed forming step S1 is a process of forming a powder bed PB on the stage 10c of the shaping table 10. The powder bed forming step S1 can be realized by, for example, (1) a step of supplying metal powder with use of the recoater 10a, and (2) a step of evenly spreading the metal powder over the stage 10c with use of the roller 10b.

The laser light irradiation step S2 is a process of forming one layer of the metal shaped object MO by irradiating the powder bed PB with laser light LL guided through the core 12a of the optical fiber 12 and with cladding light CL guided through the inner cladding 12b1 of the optical fiber 12. In the laser light irradiation step S2, (1) main heating of the powder bed PB with the laser light LL is carried out so that the temperature T of the powder bed PB is higher than 0.8 times as high as the melting point Tm of the metal powder, and (2) preheating of the powder bed PB with the cladding light CL is carried out so that the temperature T of the powder bed PB is 0.5 times to 0.8 times as high as the melting point Tm of the metal powder. The preheating at each point of the powder bed PB can be carried out before the main heating with respect to that point or can be carried out after the main heating with respect to that point. Regions irradiated with the laser light LL and the cladding light CL in the laser light irradiation step S2 are at least a part of the powder bed PB, and are determined in accordance with a layer shape of the metal shaped object MO.

The temperature T of the powder bed PB set in heating the powder bed PB with the laser light LL can be determined depending on whether each layer of the metal shaped object MO is formed by melting and solidifying the metal powder or by sintering the metal powder. In a case where the each layer of the metal shaped object MO is formed by melting and solidifying the metal powder, the main heating of the powder bed PB can be carried out with the laser light LL so that the temperature T of the powder bed PB is equal to or higher than the melting point Tm of the metal powder. Meanwhile, in a case where the each layer of the metal shaped object MO is formed by sintering metal powder, main heating of the powder bed PB can be carried out with the laser light LL so that the temperature T of the powder bed PB is higher than 0.8 times as high as the melting point Tm of the metal powder and lower than the melting point Tm of the metal powder.

The stage lowering step S3 is a process of lowering the stage 10c of the shaping table 10 by one layer. This allows a new powder bed PB to be formed on the stage 10c. A metal shaped object MO is obtained by repeating the powder bed forming step S1, the laser light irradiation step S2, and the stage lowering step S3 the number of times which corresponds to the number of layers.

The shaped object extracting step S4 is a process of extracting a resultant metal shaped object MO from the powder bed PB. Thus, the metal shaped object MO is completed.

According to the laser light irradiation step S2 and the manufacturing method S of the metal shaped object MO including the laser light irradiation step S2, it is possible to bring about an effect of keeping the residual stress small which may occur in the metal shaped object MO while keeping a time short which is to be taken for carrying out additive manufacturing of the metal shaped object MO.

(Modification Example of Metal Shaping System)

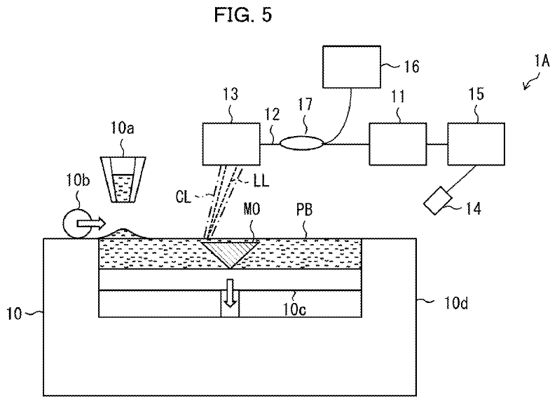

The following description will discuss a modification example of the metal shaping system 1 (hereinafter referred to as “metal shaping system 1A”) with reference to FIG. 5. FIG. 5 is a block diagram illustrating a configuration of the metal shaping system 1A.

The metal shaping system 1A is a system that is obtained by adding a cladding light source 16 and a combiner 17 to the metal shaping system 1. A shaping table 10, a laser device 11, an optical fiber 12, an irradiation device 13, a measuring section 14, and a control section 15 are configured in a manner similar to those in the metal shaping system 1. Therefore, the descriptions of those constituent members are omitted here.

The cladding light source 16 is a light source that differs from the laser device 11, which is the light source of the laser light LL. The cladding light source 16 can be any laser device such as, for example, a solid laser, a liquid laser, or a gas laser. The cladding light source 16 is connected to an input port of the combiner 17 which is inserted into the optical fiber 12. The light outputted from the cladding light source 16 is supplied to the inner cladding 12b1 of the optical fiber 12 via the combiner 17. Therefore, in the metal shaping system 1A, the light guided through the inner cladding 12b1 of the optical fiber 12 includes the light outputted from the cladding light source 16.

The control section 15 controls the cladding light source 16 so that the temperature T of the powder bed PB is 0.5 Tm≤T≤0.8 Tm in the beam spot of the cladding light CL. For example, in a case where the temperature T of the powder bed PB is lower than 0.5 Tm in the beam spot of the cladding light CL, the cladding light source 16 is controlled so that power of light outputted from the cladding light source 16 increases. In contrast, in a case where the temperature T of the powder bed PB is higher than 0.8 Tm in the beam spot of the cladding light CL, the cladding light source 16 is controlled so that power of light outputted from the cladding light source 16 decreases. In order to achieve this control, the control section 15 can refer to the temperature T of the powder bed PB measured by the measuring section 14, as with the metal shaping system 1.

According to the metal shaping device including the cladding light source 16 and the metal shaping system 1A including such a metal shaping device, it is possible to bring about effects as follows: that is, preheating can be carried out not only with residual excitation light and leaked higher order mode light but also with the cladding light source 16, and the preheating can be thus carried out at higher power. In addition, the power of the cladding light CL can be easily controlled simply by adjusting the power of the cladding light source 16. Therefore, the temperature T of the powder bed PB in the preheating can be easily controlled.

(Reference)

In order to minimize a residual stress that may occur in the metal shaped object, it is preferable to adjust the temperature T of the powder bed PB in the preheating to a value corresponding to a type of metal powder or the like. From this, it is preferable that the metal shaping device can freely set the power of the cladding light with which the powder bed PB is irradiated for the preheating. The metal shaping device included in the metal shaping system 1A described above meets this need. This is because, in the metal shaping device included in the metal shaping system 1A, the power of cladding light with which the powder bed PB is irradiated for the preheating can be freely set by selecting the cladding light source 16 as appropriate or by setting output power of the cladding light source 16 as appropriate.

A metal shaping device which can meet the above need is not limited to the metal shaping device included in the metal shaping system 1A. For example, the above need can be met provided that a metal shaping device includes (1) a first light source (e.g., the laser device 11) which outputs first light, (2) a second light source (e.g., the cladding light source 16) which outputs second light and differs from the first light source, (3) an optical fiber having a core (e.g., the core 12a) which guides the first light (e.g., the laser light LL) outputted from the first light source and a cladding (e.g., the cladding 12b) which guides the second light (e.g., the cladding light CL) outputted from the second light source, and (4) an irradiation device (e.g., the irradiation device 13) which irradiates at least a part of a powder bed (e.g., the powder bed PB) containing metal powder with the first light guided through the core and with the second light guided through the cladding, and the irradiation device heats the powder bed with the cladding light before or after heating the powder bed with the laser light. This is because, in such a metal shaping device, it is possible to freely set the power of the cladding light with which the powder bed is irradiated for preheating by selecting the second light source as appropriate or by setting output power of the second light source as appropriate.

Here, the first light can be laser light for applying main heating to the powder bed PB. Meanwhile, the second light can be laser light for applying preheating to the powder bed PB. In this case, the irradiation device 13 emits the first light and the second light so that the temperature T of the powder bed PB in a first region which is irradiated with the first light is higher than the temperature T of the powder bed PB in a second region which is irradiated with the second light. This makes it possible to carry out the preheating of the powder bed PB before or after the main heating of the powder bed PB. Therefore, it is possible to bring about the effect of keeping the residual stress small which may occur in the metal shaped object MO. In addition, the main heating with the first light and the preheating with the second light are carried out in parallel. It is therefore unnecessary to spend extra time to carry out the preheating.

Note that the first light preferably heats the powder bed PB so that the temperature T of the powder bed PB is higher than 0.8 times as high as the melting point Tm of the metal powder. In particular, in a case where each layer of the metal shaped object MO is formed by melting and solidifying the metal powder, it is preferable that the first light heats the powder bed PB so that the temperature T of the powder bed PB is higher than the melting point Tm of the metal powder. Meanwhile, in a case where each layer of the metal shaped object MO is formed by sintering metal powder, it is preferable that the first light heats the powder bed PB so that the temperature T of the powder bed PB is higher than 0.8 times as high as the melting point Tm of the metal powder and lower than the melting point Tm of the metal powder. In a case where the preheating of the powder bed PB is carried out with the second light, the second light preferably heats the powder bed PB so that the temperature T of the powder bed PB is 0.5 times to 0.8 times as high as the melting point Tm of the metal powder.

Note that a method of causing the temperature T of the powder bed PB irradiated with the second light to be lower than the temperature T of the powder bed PB irradiated with the first light can be, for example, a method of setting an energy density of the second light to be lower than an energy density of the first light. That is, by setting respective wavelengths of the first light and the second light so that the energy density of the second light becomes lower than the energy density of the first light, it is possible to cause the temperature T of the powder bed PB irradiated with the second light to be lower than the temperature T of the powder bed PB irradiated with the first light.

In a case where the energy density of the second light is lower than the energy density of the first light, the above described effects can be brought about, provided that the wavelength of the second light is longer than the wavelength of the first light. Here, in a case where the energy density of the second light is lower than the energy density of the first light, it is preferable to employ also a setting in which the wavelength of the second light is longer than the wavelength of the first light.

It is preferable that the metal shaping device “further includes a control section (e.g., the control section 15) which controls power of light outputted from the second light source”. It is further preferable that the metal shaping device “further includes a measuring section (e.g., the measuring section 14) which measures the temperature T of the powder bed and a control section (e.g., the control section 15) which controls power of light outputted from the second light source”. Here, the control section further preferably “controls the second light source based on the temperature T measured by the measuring section”. In the metal shaping device, it is preferable that “the cladding includes an inner cladding (e.g., the inner cladding 12b1) which guides the cladding light and an outer cladding (e.g., the outer cladding 12b2) which entirely covers a lateral surface of the inner cladding over an entire length of the optical fiber”. In the metal shaping device, it is preferable that “the optical fiber is provided with no cladding mode stripper for removing the cladding light”. Effects brought about by those features are as described above. Therefore, descriptions of those effects are not repeated here.

Aspects of the present invention can also be expressed as follows:

The irradiation device (13) in accordance with an aspect of the present invention is an irradiation device (13) for use in metal shaping, the irradiation device (13) including: an irradiating section (13a) which irradiates at least a part of a powder bed (PB) containing metal powder with laser light (LL) guided through a core (12a) of an optical fiber (12) and with cladding light (CL) guided through a cladding (12b) of the optical fiber (12), the irradiating section (13a) carrying out a first heating step of heating the powder bed (PB) with the laser light (LL) so that a temperature of the powder bed (PB) is higher than 0.8 times as high as a melting point (Tm) of the metal powder, and the irradiating section (13a) carrying out a second heating step of heating the powder bed (PB) with the cladding light (CL) before or after the first heating step so that a temperature of the powder bed (PB) is 0.5 times to 0.8 times as high as the melting point (Tm) of the metal powder.

According to the irradiation device (13) in accordance with an aspect of the present invention, it is preferable that the cladding (12b) includes an inner cladding (12b1) which guides the cladding light (CL) and an outer cladding (12b2) which entirely covers a lateral surface of the inner cladding (12b1) over an entire length of the optical fiber (12).

According to the irradiation device (13) in accordance with an aspect of the present invention, the optical fiber (12) is preferably provided with no cladding mode stripper for removing the cladding light (CL).

It is preferable that the irradiation device (13) in accordance with an aspect of the present invention further includes a condensing lens (13b) which forms, on a surface of the powder bed (PB), a beam spot of the laser light (LL) and a beam spot of the cladding light (CL), the beam spot of the cladding light (CL) being larger in size than the beam spot of the laser light (LL).

According to the irradiation device (13) in accordance with an aspect of the present invention, it is preferable that the laser light (LL) is laser light (LL) outputted from a fiber laser (11); and the cladding light (CL) includes residual excitation light outputted from the fiber laser (11).

According to the irradiation device (13) in accordance with an aspect of the present invention, it is preferable that the cladding light (CL) includes leaked higher order mode light which is higher order mode light leaked out from the core (12a) into the cladding (12b).

The metal shaping device in accordance with an aspect of the present invention preferably includes the irradiation device (13) in accordance with an aspect of the present invention; and the optical fiber (12) that includes the core (12a) which guides the laser light (LL) and the cladding (12b) which guides the cladding light (CL).

The metal shaping device in accordance with an aspect of the present invention preferably further includes a control section (15) which controls power of the cladding light (CL) so that a temperature of the powder bed (PB) is 0.5 times to 0.8 times as high as the melting point (Tm) of the metal powder.

The metal shaping device in accordance with an aspect of the present invention preferably further includes a measuring section (14) which measures a temperature of the powder bed (PB), the control section (15) controlling power of the cladding light (CL) based on the temperature measured by the measuring section (14).

The metal shaping device in accordance with an aspect of the present invention preferably further includes a cladding light source (16) which differs from a light source of the laser light (LL), the cladding light (CL) including cladding light (CL) outputted from the cladding light source (16).

The metal shaping system (1, 1A) in accordance with an aspect of the present invention preferably includes a metal shaping device in accordance with an aspect of the present invention; a laser device (11) which outputs the laser light (LL); and a shaping table (10) which holds the powder bed (PB).

The irradiation method in accordance with an aspect of the present invention includes: an irradiating step of irradiating at least a part of a powder bed (PB) containing metal powder with laser light (LL) guided through a core (12a) of an optical fiber (12) and with cladding light (CL) guided through a cladding (12b) of the optical fiber (12), the irradiating step including a first heating step of heating the powder bed (PB) with the laser light (LL) so that a temperature of the powder bed (PB) is higher than 0.8 times as high as a melting point (Tm) of the metal powder, and the irradiating step including a second heating step of heating the powder bed (PB) with the cladding light (CL) before or after the first heating step so that a temperature of the powder bed (PB) is 0.5 times to 0.8 times as high as the melting point (Tm) of the metal powder.

The method for manufacturing a metal shaped object (MO) in accordance with an aspect of the present invention includes: an irradiating step of irradiating at least a part of a powder bed (PB) containing metal powder with laser light (LL) guided through a core (12a) of an optical fiber (12) and with cladding light (CL) guided through a cladding (12b) of the optical fiber (12), the irradiating step including a first heating step of heating the powder bed (PB) with the laser light (LL) so that a temperature of the powder bed (PB) is higher than 0.8 times as high as a melting point (Tm) of the metal powder, and the irradiating step including a second heating step of heating the powder bed (PB) with the cladding light (CL) before or after the first heating step so that a temperature of the powder bed (PB) is 0.5 times to 0.8 times as high as the melting point (Tm) of the metal powder.

### ADDITIONAL REMARKS

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: Metal shaping system
10: Shaping table
10a: Recoater
10b: Roller
10c: Stage
10d: Table main body
11: Laser device (fiber laser)
12: Optical fiber
12a: Core
12b: Cladding
12b1: Inner cladding
12b2: Outer cladding
13: Irradiation device
13a: Galvano scanner (irradiating section)
13a1: First galvano mirror
13a2: Second galvano mirror
13b: Condensing lens
14: Measuring section
15: Control section
16: Cladding light source
17: Combiner
1A: Metal shaping system (modification example)
LL: Laser light
CL: Cladding light
PB: Powder bed
MO: Metal shaped object
T: Temperature of powder bed
Tm: Melting point of metal powder

1. An irradiation device for use in metal shaping, said irradiation device comprising:
an irradiating section which irradiates at least a part of a powder bed containing metal powder with laser light guided through a core of an optical fiber and with cladding light guided through a cladding of the optical fiber,
the irradiating section carrying out a first heating step of heating the powder bed with the laser light so that a temperature of the powder bed is higher than 0.8 times as high as a melting point of the metal powder, and
the irradiating section carrying out a second heating step of heating the powder bed with the cladding light before or after the first heating step so that a temperature of the powder bed is 0.5 times to 0.8 times as high as the melting point of the metal powder.

2. The irradiation device as set forth in claim 1, wherein:
the cladding includes an inner cladding which guides the cladding light and an outer cladding which entirely covers a lateral surface of the inner cladding over an entire length of the optical fiber.

3. The irradiation device as set forth in claim 1, wherein the optical fiber is provided with no cladding mode stripper for removing the cladding light.

4. The irradiation device as set forth in claim 1, further comprising:
a condensing lens which forms, on a surface of the powder bed, a beam spot of the laser light and a beam spot of the cladding light, the beam spot of the cladding light being larger in size than the beam spot of the laser light.

5. The irradiation device as set forth in claim 1, wherein:
the laser light is laser light outputted from a fiber laser; and
the cladding light includes residual excitation light outputted from the fiber laser.

6. The irradiation device as set forth in claim 1, wherein:
the cladding light includes leaked higher order mode light which is higher order mode light leaked out from the core into the cladding.

7. A metal shaping device comprising:
an irradiation device recited in claim 1; and
the optical fiber that includes the core which guides the laser light and the cladding which guides the cladding light.

8. The metal shaping device as set forth in claim 7, further comprising:
a control section which controls power of the cladding light so that a temperature of the powder bed is 0.5 times to 0.8 times as high as the melting point of the metal powder.

9. The metal shaping device as set forth in claim 8, further comprising:
a measuring section which measures a temperature of the powder bed,
the control section controlling power of the cladding light based on the temperature measured by the measuring section.

10. The metal shaping device as set forth in claim 7, further comprising:
a cladding light source which differs from a light source of the laser light,
the cladding light including cladding light outputted from the cladding light source.

11. A metal shaping system, comprising:
a metal shaping device recited in claim 7;
a laser device which outputs the laser light; and
a shaping table which holds the powder bed.

12. An irradiation method comprising:
an irradiating step of irradiating at least a part of a powder bed containing metal powder with laser light guided through a core of an optical fiber and with cladding light guided through a cladding of the optical fiber,
the irradiating step including a first heating step of heating the powder bed with the laser light so that a temperature of the powder bed is higher than 0.8 times as high as a melting point of the metal powder, and
the irradiating step including a second heating step of heating the powder bed with the cladding light before or after the first heating step so that a temperature of the powder bed is 0.5 times to 0.8 times as high as the melting point of the metal powder.

13. A method for manufacturing a metal shaped object, said method comprising:
an irradiating step of irradiating at least a part of a powder bed containing metal powder with laser light guided through a core of an optical fiber and with cladding light guided through a cladding of the optical fiber,
the irradiating step including a first heating step of heating the powder bed with the laser light so that a temperature of the powder bed is higher than 0.8 times as high as a melting point of the metal powder, and
the irradiating step including a second heating step of heating the powder bed with the cladding light before or after the first heating step so that a temperature of the powder bed is 0.5 times to 0.8 times as high as the melting point of the metal powder.
